(19) United States
(12) Patent Application Publication
(10) Pub. No.: US 2017/0009452 A1
(43) Pub. Date: Jan. 12, 2017

(54) RETAINING WALL SYSTEM USING INTERLOCKING CONCRETE MASONRY UNITS

(71) Applicants: Mark Holtzapple, College Station, TX (US); Mark T. Holtzapple, College Station, TX (US)

(72) Inventors: Mark Holtzapple, College Station, TX (US); Mark T. Holtzapple, College Station, TX (US)

(21) Appl. No.: 15/206,117

(22) Filed: Jul. 8, 2016

Related U.S. Application Data
(60) Provisional application No. 62/193,062, filed on Jul. 15, 2015.
(60) Provisional application No. 62/191,313, filed on Jul. 10, 2015.

(51) Int. Cl. E04C 1/00; B28B 7/00; B28B 7/18

(52) U.S. Cl. CPC E04C 1/00; B28B 7/183; B28B 7/0091; B28B 7/0002

(57) ABSTRACT

The present disclosure is directed to a new and improved family of cement block designs that have notches included therein to allow interconnectivity. In particular embodiments, the notched interconnectivity strengthens the combined block structure as compared to a structure of combined conventional blocks. Alternative embodiments replace notches with clips that create interconnectivity.

### CROSS-REFERENCE TO RELATED APPLICATIONS

The present application is related to U.S. Provisional Patent Application No. 62,191,313, which was filed on Jul. 10, 2015, and entitled “CEMENT BLOCKS HAVING NOTCHES FOR INTERCONNECTIVITY” and U.S. Provisional Patent Application No. 62/193,062, which was filed on Jul. 15, 2015, and entitled “RETAINING WALL SYSTEM USING INTERBLOCKING CONCRETE MASONRY UNITS.” U.S. Provisional Patent Application Nos. 62,191,313 and 62/193,062 are hereby incorporated by reference into the present application as if fully set forth herein. The present application hereby claims priority under 35 U.S.C. §119(e) to U.S. Provisional Patent Nos. 62,191,313 and 62/193,062.

### TECHNICAL FIELD

This disclosure is generally directed to cement block designs. More specifically, this disclosure is directed to a retaining wall system using interlocking concrete masonry units.

### BACKGROUND

Concrete masonry units (CMU) are also called concrete bricks, concrete blocks, cement blocks, besser blocks, breeze blocks, and cinder blocks. Here, the term “cement block” will be employed.

Cement blocks are ubiquitous and produced all over the world. Furthermore, they are extremely inexpensive. Commonly, they are used to construct buildings; however, they can also be used to construct retaining walls.

### SUMMARY OF THE DISCLOSURE

The present disclosure is directed to a new and improved family of cement block designs that have notches included therein to allow interconnectivity. In particular embodiments, the notched interconnectivity strengthens the combined block structure as compared to a structure of combined conventional blocks. Alternative embodiments replace notches with clips that create interconnectivity.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like.

### BRIEF DESCRIPTION OF THE DRAWINGS

For a more complete understanding of this disclosure and its features, reference is now made to the following description, taken in conjunction with the accompanying drawings, in which:

FIG. 1 is a collapsed retaining wall constructed from cement blocks joined by mortar;

FIG. 2 is a base layer of cement blocks;

FIG. 3 is a second layer of cement blocks added to base layer of FIG. 2;

FIG. 4 show a second layer of cement blocks with notches to create interlocking blocks, according to an embodiment of the disclosure;

FIG. 5 is a bottom view of cement block of FIG. 4, showing six notches;

FIG. 6 is a side view of stacked cement blocks described in FIG. 4 where blocks are oriented in the same direction;

FIG. 7 is a side view of stacked cement blocks described in FIG. 4 where blocks are oriented in the alternating directions;

FIG. 8 is a second layer of cement blocks with double set of notches, according to another embodiment of the disclosure.

FIG. 9 is a side view of stacked cement blocks described in FIG. 8; and

FIG. 10 shows conventional cement blocks without notches joined with interlocking right-angle clips; and

FIG. 11 shows conventional cement blocks without notches joined with interlocking parallel-angle clips.

### DETAILED DESCRIPTION

The FIGURES described below, and the various embodiments used to describe the principles of the present disclosure in this patent document are by way of illustration only and should not be construed in any way to limit the scope of the disclosure. Those skilled in the art will understand that the principles of the present disclosure invention may be implemented in any type of suitably arranged device or system. Additionally, the drawings are not necessarily drawn to scale.

Concrete masonry units (CMU) are also called concrete bricks, concrete blocks, cement blocks, besser blocks, breeze blocks, and cinder blocks. Here, the term “cement block” will be employed.

Cement blocks are ubiquitous and produced all over the world. Furthermore, they are extremely inexpensive. Commonly, they are used to construct buildings; however, they can also be used to construct retaining walls.

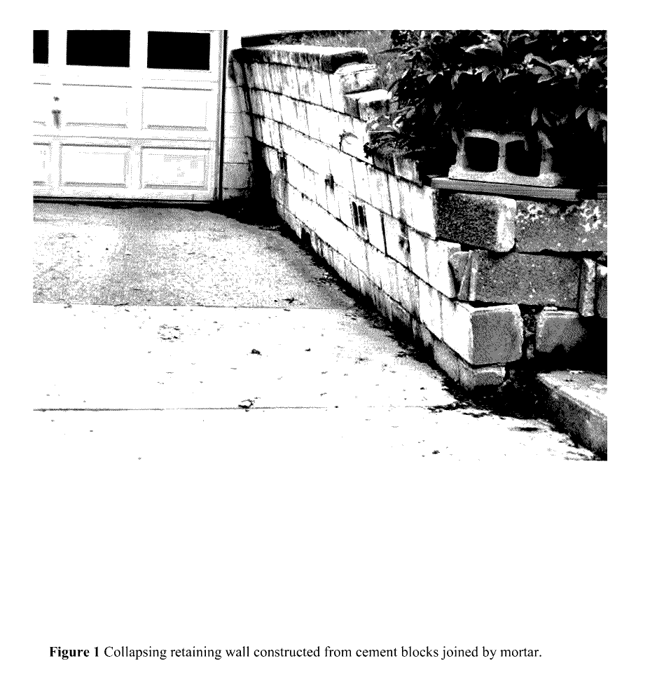

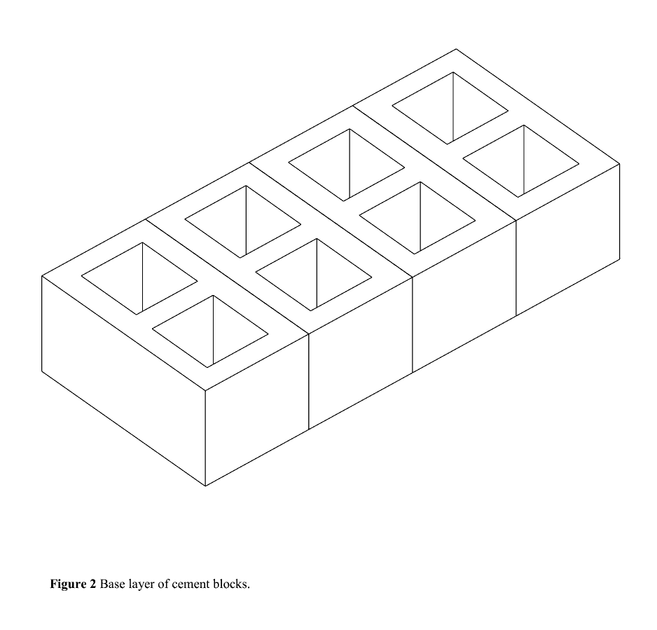

FIG. 1 shows a collapsing retaining wall constructed from cement blocks joined by mortar. When used in the conventional manner joined with mortar such as shown in FIG. 1, cement blocks are not particularly strong. Strength can be significantly increased by laying the cement blocks as shown in FIG. 2, which has double the depth compared to the conventional approach shown in FIG. 1.

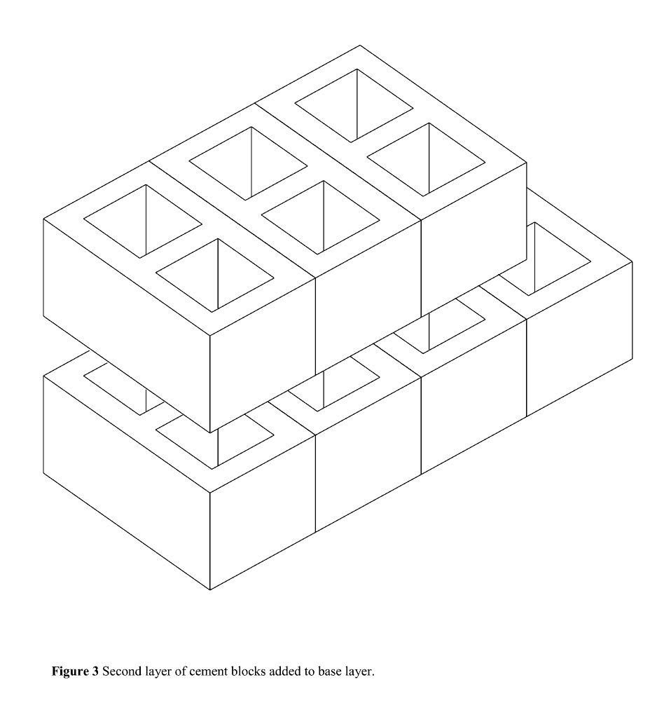

FIG. 3 shows a second layer of cement blocks added in an offset and overlapping manner to the base layer of FIG. 2. If such a wall were joined with cement, it would not be strong because there is little contact area between the layers.

With the identified concerns of configurations shown in FIGS. 1 through 3, certain embodiments of the disclosure provide a better approach for interconnecting cement block. In particular, certain embodiments allow an interconnectivity through placement of notches in the cement blocks.

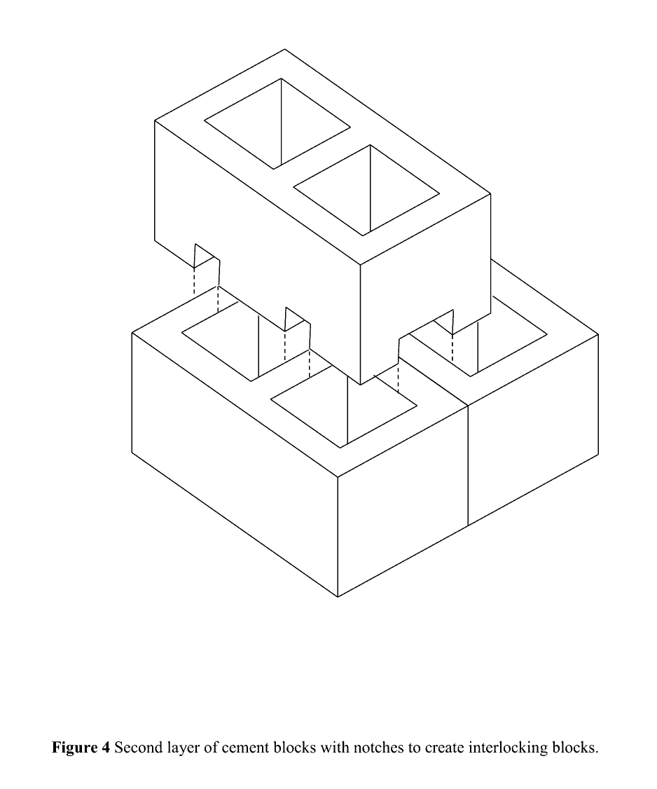

FIG. 4 shows an example notch in a cement blocks, according to an embodiment of the disclosure. In FIG. 4, the block on the second layer has six notches (three of which are seen), which interlock the blocks creating a much stronger wall than that shown in FIG. 3. Among other things, the surface area contact is increased. Also the interconnectivity restricts lateral movement—not only of one block with respect to another, but also (in this figure) three blocks with respect to each other.

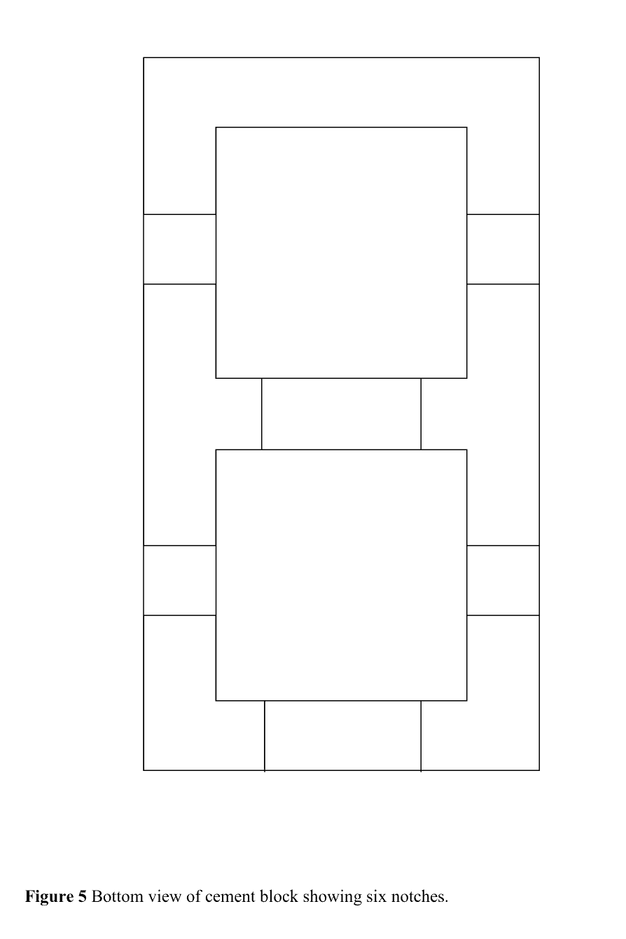

FIG. 5 shows a bottom view of the second-layer block of FIG. 4 in which the six notches are readily seen. Although this particular location is provided, one of ordinary skill in the art will recognize that the notches can be placed in other locations.

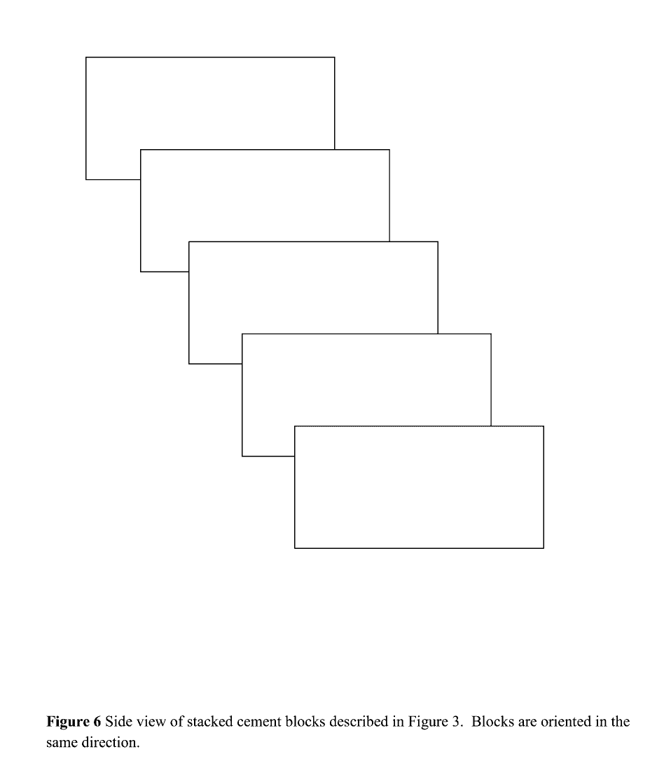

FIG. 6 shows a sloped wall constructed from the cements blocks described in FIG. 4. Each block is oriented in the same direction.

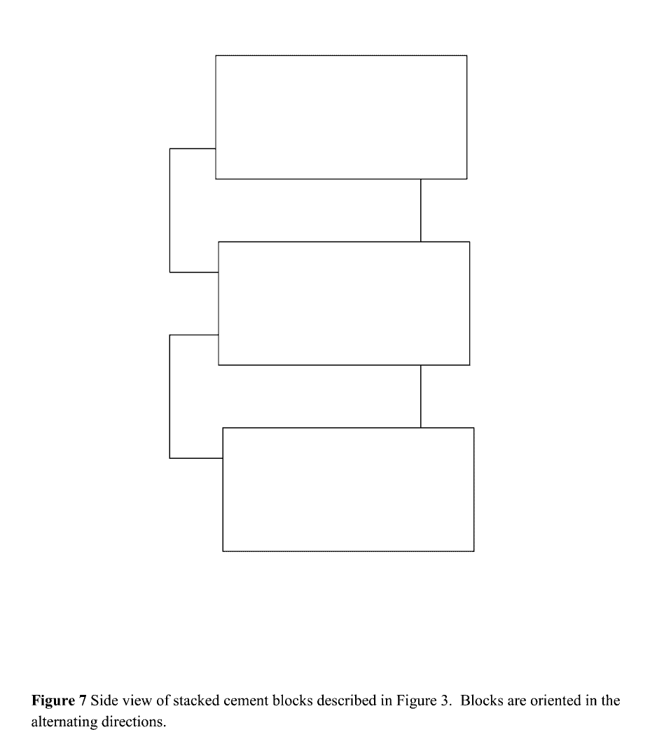

FIG. 7 shows the cement blocks stacked so as to create a vertical retaining wall. Each block is oriented in an alternating direction.

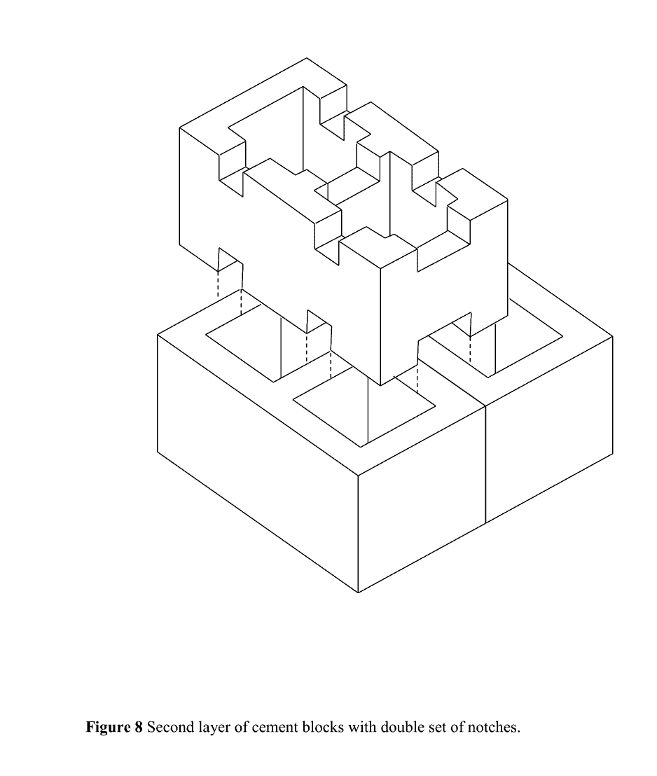

FIG. 8 shows a second layer of cement blocks with a double set of notches, one set on the bottom and the other set on top. This system allows every other layer to be constructed of conventional un-notched cement blocks. The intermediate layers are notched.

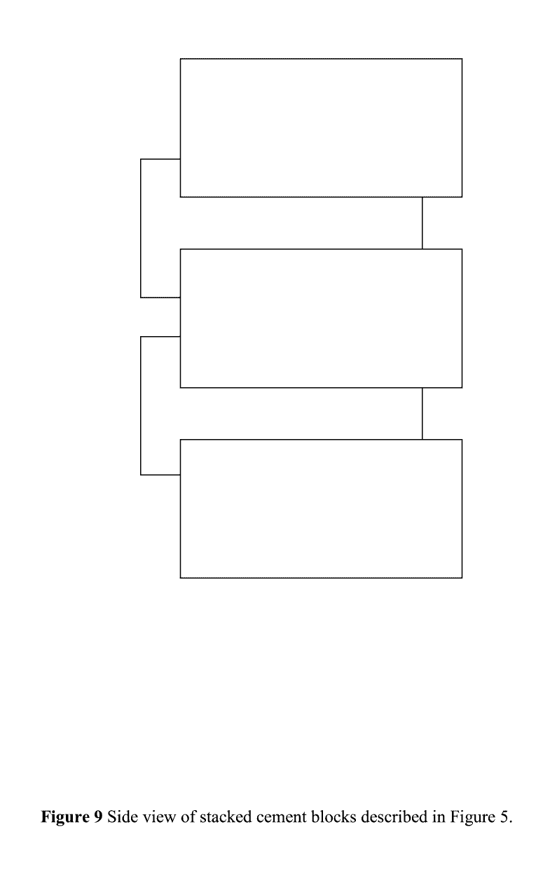

FIG. 9 shows a vertical wall constructed from the cements blocks described in FIG. 8.

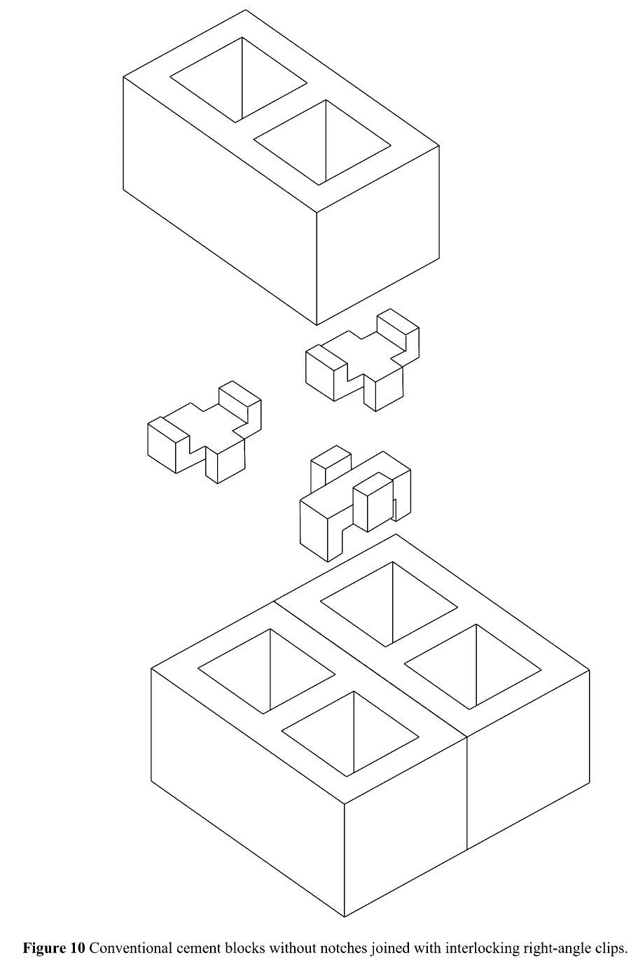

FIG. 10 shows an alternative approach that employs clips to join the blocks together. Each clip employs channels in the x and y axes onto which webs of the adjoining cement blocks can be aligned. In one axis, the clip is the width of two webs. In the other axis, it is the width of one web. The clips can be made from any suitable material such as metal, plastic, cement, or ceramic. For additional strength, the latter three materials can be reinforced with fibers. FIG. 10 shows three clips; however, fewer or more can be employed. For additional strength, the clips can be bonded to the cement blocks using suitable mortar or glue, such as epoxy.

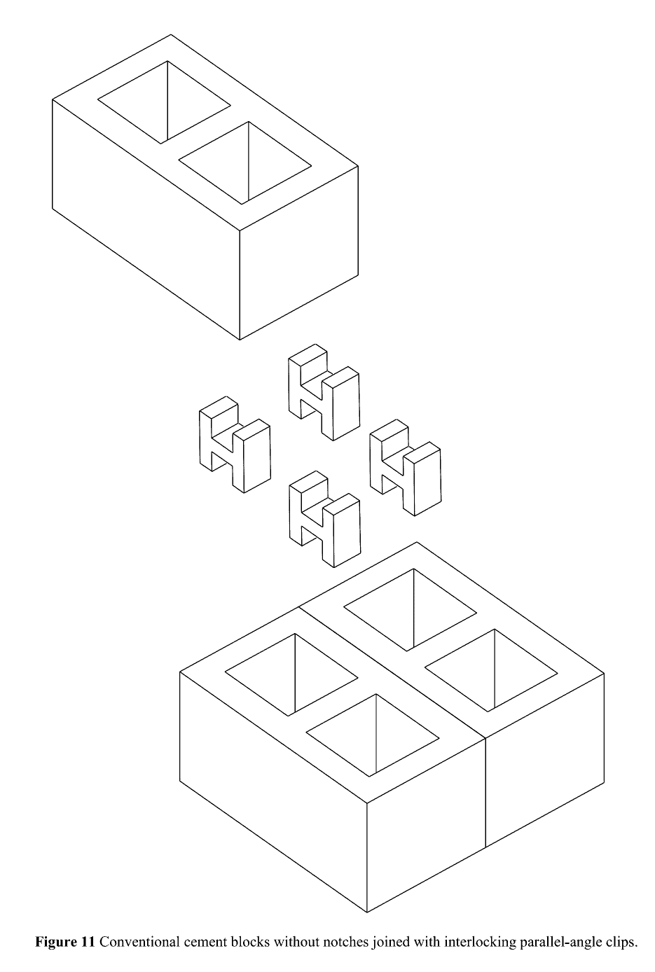

FIG. 11 shows an alternative approach that employs parallel-angle clips to join the blocks together. Each clip employs channels in only the x axis onto which webs of the adjoining cement blocks can be aligned. In each axis, the clip is the width of one web. The clips can be made from any suitable material such as metal, plastic, cement, or ceramic. For additional strength, the latter three materials can be reinforced with fibers. FIG. 11 shows four clips; however, fewer or more can be employed. For additional strength, the clips can be bonded to the cement blocks using mortar or suitable glue, such as epoxy.

To create yet additional strength, the void space in the concrete blocks can be filled with rebar and cement.

The sloped wall shown in FIG. 6 can be filled with soil allowing plants (e.g., vines) to grow on the wall, thus creating a “living wall.”

In particular embodiments, the wall may be constructed from conventional concrete blocks; however, the blocks can be decorative with attractive textures or colors on the face.

In particular embodiments, the notched designs can be created by taking existing concrete block molds and retrofitting them with the notch to not “fill” an otherwise fillable area. Thus, using such a manufacturing technique, an owner of molds need not purchase additional molds. They need only insert the additional retrofit pieces.

This retrofit approach to manufacturing interlocking pieces by removing material from an otherwise conventional block has advantages over alternative strategies that would add to (as opposed to remove from) an otherwise conventional block. The add-to alternative strategy is much more expensive and difficult to implement because additional hardware and manufacturing steps are required.

Although a retrofit design has been described with reference to particular embodiments to avail from existing molds, other embodiments may be specifically design a mold with a notched design in mind. Moreover, some mold designs may have dynamically changeable pieces to slightly modify where notches are placed.

Although particular location of notches have been describe herein, after review of this disclosure, one of ordinary skill in the art will recognize that notches may be placed in other locations. As a non-limiting example, in FIG. 4, the interconnectivity may be enabled by notches on both layers as opposed to one layer shown.

Additionally, although particular types of cement blocks have been shown, other types of cement blocks may be utilized with notches therein. Such other types of cements blocks may include blocks with one hole, three or more holes, and holes with different sizes. Such cement blocks may be standard ones or non-standard ones. Retrofit and dynamic retrofit may apply to any of preceding.

Additionally, although “cement” is described as a particular material for blocks, in some embodiments, other materials may be utilized.

While this disclosure has described certain embodiments and generally associated methods, alterations and permutations of these embodiments and methods will be apparent to those skilled in the art. Accordingly, the above description of example embodiments does not define or constrain this disclosure. Other changes, substitutions, and alterations are also possible without departing from the spirit and scope of this disclosure, as defined by the following claims.

What is claimed is:

1. An cement block system configuration comprising:
one or more notches configured to allow connectivity with another cement block.

2. A method of manufacturing interlocking blocks from traditional cement block molds comprising:
adding a retrofit to an existing mold design to remove filling of a portion corresponding to one or more notches, the one or more notches configured to allow connectivity with another cement block.

3. A clip configured to couple two different cement blocks to one another comprising:
portions configured to extend into the voids of at least two different cement blocks.

4. The clip of claim 3, wherein the two or more clips are configured to work together in coupling two cement blocks to one another.
